(19) United States
(12) Patent Application Publication
(10) Pub. No.: US 2011/0043507 A1
(43) Pub. Date: Feb. 24, 2011

(54) PLASMA DISPLAY DEVICE AND METHOD OF DRIVING THE SAME

(76) Inventor: Jin-Ho Yang, Yongin-si (KR)

Correspondence Address: CHRISTIE, PARKER & HALE, LLP, PO BOX 7068, PASADENA, CA, 91109-7068, US

(21) Appl. No.: 12/850,558

(22) Filed: Aug. 4, 2010

(30) Foreign Application Priority Data
Aug. 18, 2009 (KR) 10-2009-0076411

(51) Int. Cl. G06F 3/038

(52) U.S. Cl. 345/211

(57) ABSTRACT

In a plasma display device, a capacitor is coupled between the high voltage terminal and the low voltage terminal of a scan circuit. During a first period of a falling period of a reset period, voltage of a scan electrode is gradually decreased to a first voltage through the low voltage terminal and the capacitor. Next, during a second period of the falling period, the voltage of the scan electrode is gradually decreased from the first voltage to a second voltage through the low voltage terminal without through the capacitor.

### CROSS-REFERENCE TO RELATED APPLICATIONS

This application claims priority to and the benefit of Korean Patent Application No. 10-2009-0076411 filed in the Korean Intellectual Property Office on Aug. 18, 2009, the entire content of which is incorporated herein by reference.

### BACKGROUND

1. Field of the Invention

The present invention relates to a plasma display device and a method of driving the same.

2. Description of the Related Art

A plasma display device includes a plurality of display electrodes and a plurality of discharge cells defined by the plurality of display electrodes. A turn-on discharge cell (hereinafter referred to as an “on cell”) and a turn-off discharge cell (hereinafter referred to as an “off cell”) are selected from the plurality of discharge cells, and the on cells are discharged to thereby display an image.

Before the on cell and the off cell are selected, the plasma display device generates a weak discharge in the discharge cell by gradually increasing the voltage of the display electrode and resets the charge state of the discharge cell through the weak discharge. In order to gradually increase the voltage of the display electrode, the plasma display device repeats the on/off operations of a transistor coupled to the display electrode or controls the current supplied to the gate of the transistor.

However, when the voltage of the display electrode gradually decreases, current is supplied through the transistor due to a capacitive component formed by the display electrode. Thus, power continues to be consumed in the transistor because of the current, and so the amount of heat generated in the transistor is increased. Furthermore, such generation of heat causes a large heat sink to be attached to the transistor, resulting in a thick plasma display device.

The above information disclosed in this Background section is only for enhancement of understanding of the background of the described technology, and therefore it may contain information that does not form the prior art that is already known to a person of ordinary skill in the art.

### SUMMARY OF THE INVENTION

An aspect of the present invention is directed toward a plasma display device and a method of driving the same, capable of reducing the amount of heat generated in a transistor.

According to an exemplary embodiment, there is provided a plasma display device, including a scan electrode, a scan circuit, a first capacitor, a first transistor, a first falling reset controller, a second transistor, and a second falling reset controller. The scan circuit has a high voltage terminal and a low voltage terminal and is configured to set a voltage of the scan electrode to a voltage of the high voltage terminal or a voltage of the low voltage terminal. The first capacitor is coupled between the high voltage terminal and the low voltage terminal. The first transistor is coupled between the high voltage terminal and a first power supply for supplying a first voltage. The first falling reset controller is configured to operate the first transistor such that the voltage of the scan electrode gradually decreases to a second voltage through the low voltage terminal and the first capacitor during a first period of a reset period. The second transistor is coupled between the low voltage terminal and a second power supply for supplying a third voltage that is lower than the second voltage. The second falling reset controller is configured to operate the second transistor such that the voltage of the scan electrode gradually decreases from the second voltage to a fourth voltage that is lower than the second voltage through the low voltage terminal during a second period of the reset period.

The plasma display device may further include a third transistor coupled in series to the first transistor between the high voltage terminal and the first power supply. A node between the first transistor and the third transistor may be coupled to a third power supply for supplying a fifth voltage higher than the first voltage.

The first falling reset driver may gradually decrease the voltage of the scan electrode to a sixth voltage that is higher than the second voltage through a path formed from the low voltage terminal to the third power supply via the first capacitor and the first transistor during a third period of the first period, and gradually decrease the voltage of the scan electrode to the second voltage through a path formed from the low voltage terminal to the first power supply via the first capacitor and the first and third transistors during a fourth period of the first period.

Furthermore, the plasma display device may further include a comparator configured to turn on the third transistor when the fifth voltage is higher than the voltage of the high voltage terminal.

According to another exemplary embodiment, there is provided a method of driving a plasma display device, including a scan electrode, a scan circuit having a high voltage terminal and a low voltage terminal and configured to set a voltage of the scan electrode to a voltage of the high voltage terminal or a voltage of the low voltage terminal, and a capacitor coupled between the high voltage terminal and the low voltage terminal. The method includes electrically coupling the low voltage terminal to the scan electrode during a falling period of a reset period, gradually decreasing the voltage of the scan electrode to a first voltage through the low voltage terminal and the capacitor during a first period of the falling period, and gradually decreasing the voltage of the scan electrode from the first voltage to a second voltage through the low voltage terminal without utilizing the capacitor during a second period of the falling period.

According to yet another exemplary embodiment, there is provided a plasma display device, including a scan electrode, a scan circuit, first and second capacitors, a first current cut-off element, first and second transistors, first and second resistors, and first and second gate drivers. The scan circuit has a high voltage terminal and a low voltage terminal and is configured to set a voltage of the scan electrode to a voltage of the high voltage terminal or a voltage of the low voltage terminal. The first capacitor is coupled between the high voltage terminal and the low voltage terminal. The first current cut-off element has a first terminal and a second terminal coupled to the high voltage terminal and is configured to block a current from the first terminal toward the second terminal. The first transistor has a drain coupled to the first terminal of the first current cut-off element. The first resistor has a first terminal coupled to a source of the first transistor and a second terminal coupled to a first power supply for supplying a first voltage. The first gate driver is configured to utilize a voltage of the second terminal of the first resistor as a reference and to supply a first gate signal to a gate of the first transistor. The second transistor is coupled between the low voltage terminal and a second power supply for supplying a second voltage. The second capacitor is coupled between the drain and the gate of the second transistor. The second gate driver is configured to utilize a source voltage of the second transistor as a reference and to output a second gate signal to an output terminal of the second gate driver and outputs the second gate signal to its output terminal. The second resistor is coupled between the output terminal of the second gate driver and the gate of the second transistor.

According to the exemplary embodiments, power consumption of a transistor may be reduced. Accordingly, a heat sink attached to the transistor may be reduced in size or may be removed.

### BRIEF DESCRIPTION OF THE DRAWINGS

FIG. 1 is a schematic block diagram of a plasma display device according to an exemplary embodiment;

FIG. 2 is a diagram schematically showing driving waveforms of a plasma display device according to an exemplary embodiment;

FIG. 3 is a schematic circuit diagram of a scan electrode driver according to an exemplary embodiment;

FIG. 4 is a diagram showing voltages of a falling reset driver according to an exemplary embodiment;

FIG. 5 is a diagram showing voltages of a falling reset driver according to an exemplary embodiment;

FIG. 6 is a schematic circuit diagram of a falling reset driver according to an exemplary embodiment;

FIG. 7 is a diagram showing voltages of a falling reset driver according to another exemplary embodiment;

FIG. 8 is a schematic circuit diagram of a scan electrode driver according to an exemplary embodiment; and

FIG. 9 is a schematic circuit diagram of a falling reset driver according to an exemplary embodiment.

### DETAILED DESCRIPTION

In the following detailed description, certain exemplary embodiments have been shown and described, simply by way of illustration. As those skilled in the art would realize, the described embodiments may be modified in various different ways, all without departing from the spirit or scope of the exemplary embodiments. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising,” will be understood to imply the inclusion of stated elements but not the exclusion of any other elements.

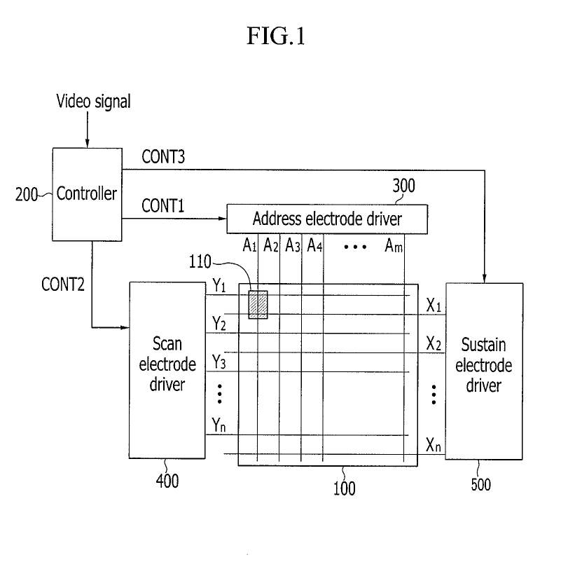

FIG. 1 is a schematic block diagram of a plasma display device according to an exemplary embodiment.

Referring to FIG. 1, the plasma display device includes a plasma display panel (PDP) 100, a controller 200, an address electrode driver 300, a scan electrode driver 400, and a sustain electrode driver 500.

The PDP 100 includes a plurality of display electrodes Y1-Yn and X1-Xn, a plurality of address electrode (hereinafter referred to as “A electrodes”) A1-Am, and a plurality of discharge cells 110.

The plurality of display electrodes Y1-Yn and X1-Xn includes a plurality of scan electrodes (hereinafter referred to as “Y electrodes”) Y1-Yn and a plurality of sustain electrodes (hereinafter referred to as “X electrodes”) X1-Xn. The Y electrodes Y1-Yn and the X electrodes X1-Xn are configured to extend substantially in a row direction and are substantially parallel to each other. The A electrodes A1-Am are configured to extend in a column direction and are substantially parallel to each other. The Y electrodes Y1-Yn and the X electrodes X1-Xn may correspond to each other in a one-to-one manner. Alternatively, two X electrodes may correspond to one Y electrode, or two Y electrodes may correspond to one X electrode. The discharge cells 110 are formed in respective spaces which are defined by the A electrodes A1-Am, the Y electrodes Y1-Yn, and the X electrodes X1-Xn.

The above described structure of the PDP 100 is an example, and the PDP 100 may have a different structure according to another exemplary embodiment.

The controller 200 receives a video signal and input control signals to control display of the video signal. The video signal includes luminance information about each of the discharge cells 110, and the luminance of each discharge cell 110 can be represented by one of a plurality of gray levels having a number (e.g., a predetermined number). The input control signals can include, for example, a vertical synchronization signal and a horizontal synchronization signal.

The controller 200 divides one frame for displaying an image into a plurality of subfields each having a luminance weight value. At least one of the subfields includes a reset period, an address period, and a sustain period. The controller 200 processes the video signal and the input control signals in accordance with the plurality of subfields and generates an A electrode driving control signal (CONT1), a Y electrode driving control signal (CONT2), and an X electrode driving control signal (CONT3). The controller 200 outputs the A electrode driving control signal (CONT1) to the address electrode driver 300, the Y electrode driving control signal (CONT2) to the scan electrode driver 400, and the X electrode driving control signal (CONT3) to the sustain electrode driver 500.

Furthermore, the controller 200 converts an input video signal corresponding to each discharge cell 110 into subfield data indicative of a light emitting or non-light emitting state of the discharge cell 110 in a plurality of subfields. The A electrode driving control signal (CONT1) includes the subfield data.

The scan electrode driver 400 sequentially applies a scan voltage to the Y electrodes Y1-Yn in the address period in response to the Y electrode driving control signal (CONT2). The address electrode driver 300 supplies to the A electrodes A1-Am with voltage for distinguishing on cells and off cells in the plurality of discharge cells 110 which are coupled to a Y electrode to which the scan voltage has been applied in response to the A electrode driving control signal (CONT1).

After the on cells and the off cells are distinguished (or selected) in the address period, the scan electrode driver 400 and the sustain electrode driver 500 alternately apply respective sustain pulses for a number of times corresponding to a luminance weight value of each subfield to the Y electrodes Y1-Yn and the X electrodes X1-Xn, respectively, in the sustain period in response to the Y electrode driving control signal (CONT2) and the X electrode driving control signal (CONT3), respectively.

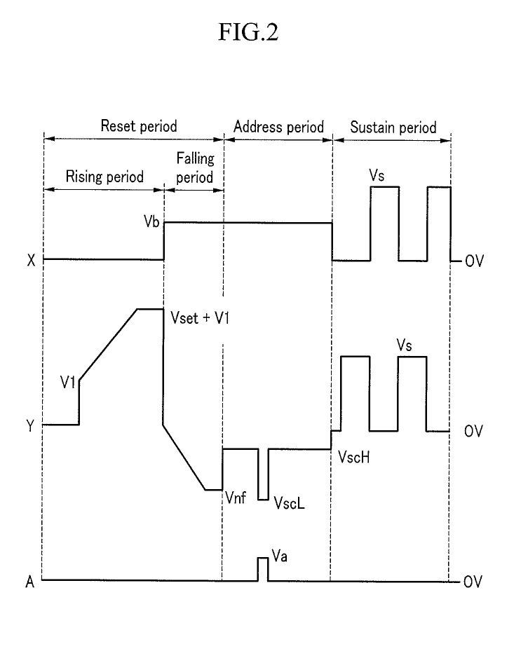

FIG. 2 is a diagram schematically showing driving waveforms of the plasma display device according to an exemplary embodiment.

FIG. 2 shows one subfield of the plurality of subfields, for the convenience of description. Driving waveforms applied to a Y electrode, an X electrode, and an A electrode forming one discharge cell are described.

Referring to FIG. 2, in a rising period of the reset period, in the state in which the address electrode driver 300 and the sustain electrode driver 500 have applied respective voltages (e.g., ground voltages in FIG. 2) to the A electrode and the X electrode, the scan electrode driver 400 gradually increases the voltage of the Y electrode from a V1 voltage up to a (V1+Vset) voltage in which a Vset voltage is added to the V1 voltage and sustains the voltage of the Y electrode at the (V1+Vset) voltage for a certain period of time. For example, the scan electrode driver 400 may increase the voltage of the Y electrode in a ramp pattern. While the voltage of the Y electrode gradually increases, a weak discharge is generated between the Y electrode and the X electrode and between the Y electrode and the A electrode. Accordingly, negative charges may be formed in the Y electrode, and positive charges may be formed in the X electrode and the A electrode. Here, the V1 voltage may be, for example, a voltage difference between a VscH voltage and a VscL voltage (VscH−VscL) which will be described later in more detail.

Next, in a falling period of the reset period, in the state in which the address electrode driver 300 and the sustain electrode driver 500 have applied the ground voltage and a Vb voltage to the A electrode and the X electrode, respectively, the scan electrode driver 400 gradually decreases the voltage of the Y electrode from a ground voltage to a Vnf voltage. For example, the scan electrode driver 400 may decrease the voltage of the Y electrode in a ramp pattern. While the voltage of the Y electrode gradually decreases, a weak discharge is generated between the Y electrode and the X electrode and between the Y electrode and the A electrode. Accordingly, the negative charges formed in the Y electrode and the positive charges formed in the X electrode and the A electrode during the rising period may be erased. Accordingly, the discharge cell 110 may be reset. In this embodiment, the Vnf voltage may be set to a negative voltage, and the Vb voltage may be set to a positive voltage. Further, a voltage difference between the Vb voltage and the Vnf voltage (Vb−Vnf) may be set to a value close to a discharge firing voltage between the Y electrode and the X electrode, and so the reset discharge cell may be set to an off cell. Alternatively, in the falling period, the voltage of the Y electrode may gradually decrease from a voltage different from the ground voltage.

In the address period, in order to distinguish an on cell and an off cell, in the state in which the sustain electrode driver 500 has applied the Vb voltage to the X electrode, the scan electrode driver 400 sequentially applies a scan pulse having a VscL voltage (scan voltage) to the plurality of scan electrodes (Y1-Yn in FIG. 1). Simultaneously (or concurrently), the address electrode driver 300 applies a Va voltage (address voltage) to an A electrode of a cell which has been determined to be the on cell, from among a plurality of discharge cells formed by the Y electrode to which the VscL voltage has been applied. Accordingly, an address discharge is generated in a discharge cell formed by the A electrode to which the Va voltage has been applied and the Y electrode to which the VscL voltage has been applied, thereby being capable of forming positive charges in the Y electrode and forming negative charges in the A electrode and the X electrode. Furthermore, the scan electrode driver 400 can apply a VscH voltage (non-scanning voltage) which is higher than the VscL voltage to Y electrodes to which the VscL voltage has not been applied, and the address electrode driver 300 can apply a ground voltage to A electrodes to which the Va voltage has not been applied. In FIG. 2, the VscL voltage may have a negative voltage, and the Va voltage may have a positive voltage.

In the sustain period, the scan electrode driver 400 and the sustain electrode driver 500 apply respective sustain pulses which alternately have a high voltage (Vs) and a low voltage (e.g., ground voltage) to the Y electrode and the X electrode, respectively. That is, when the high voltage (Vs) is applied to the Y electrode while the low voltage is applied to the X electrode, a sustain discharge is generated in an on cell because of a voltage difference between the high voltage (Vs) and the low voltage. Next, when the low voltage is applied to the Y electrode and the high voltage (Vs) is applied to the X electrode, a sustain discharge is generated in the on cell because of a voltage difference between the high voltage (Vs) and the low voltage. This operation is repeatedly performed in the sustain period, and the sustain discharge is performed for a number of times corresponding to a luminance weight value of a corresponding subfield. In another embodiment, in the state in which the ground voltage is applied to one electrode (e.g., the X electrode) of the Y electrode and the X electrode, sustain pulses alternately having the Vs voltage and a −Vs voltage are applied to the other electrode (e.g., the Y electrode).

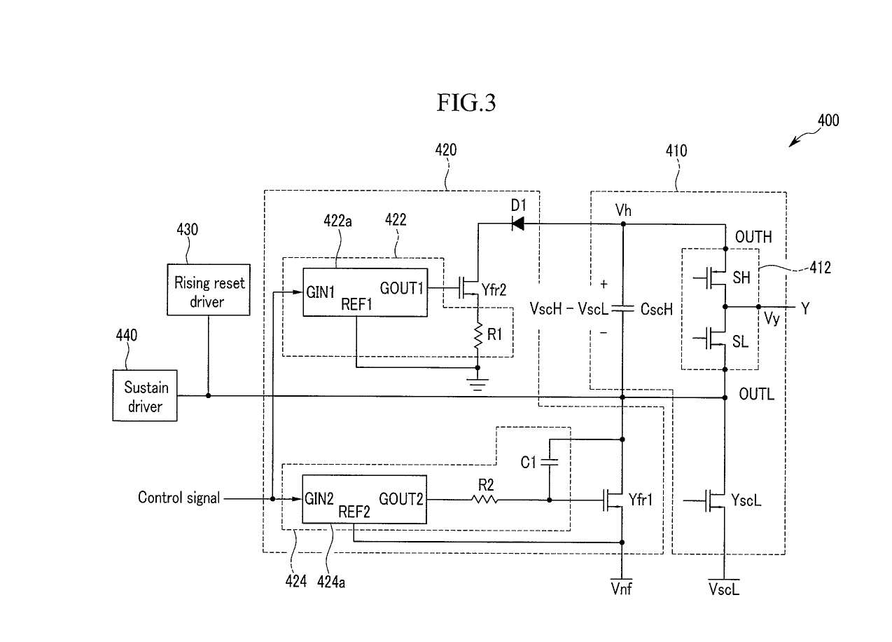

The scan electrode driver 400 according to an exemplary embodiment is described below with reference to FIG. 3.

FIG. 3 is a schematic circuit diagram of the scan electrode driver 400 according to the exemplary embodiment.

Referring to FIG. 3, the scan electrode driver 400 includes a scan driver 410, a falling reset driver 420, a rising reset driver 430, and a sustain driver 440.

The scan driver 410 includes a scan circuit 412, a capacitor CscH, and a transistor YscL. The scan circuit 412 includes a high voltage terminal OUTH, a low voltage terminal OUTL, and an output terminal OUT. The scan circuit 412 may further include two transistors SH and SL. The scan circuit 412 sequentially applies the scan pulse having the VscL voltage to the plurality of Y electrodes in the address period.

The falling reset driver 420 includes transistors Yfr1 and Yfr2, a current cut-off element D1 (e.g., a diode), and falling reset controllers 422 and 424, and the falling reset driver 420 gradually decreases the voltage of the Y electrode to the Vnf voltage in the falling period of the reset period.

The rising reset driver 430 gradually increases the voltage of the Y electrode in the rising period of the reset period.

The sustain driver 440 alternately applies the Vs voltage and 0V (or ground voltage) to the Y electrode in the sustain period.

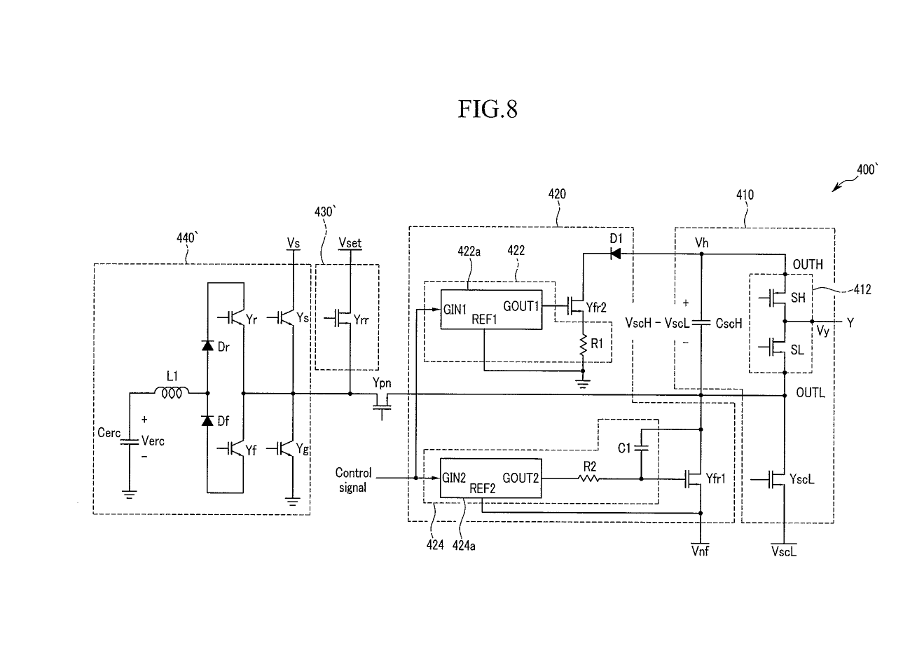

Each of the transistors YscL, Yfr1, Yfr2, SH, and SL is an example of a switch having a control terminal, an input terminal, and an output terminal, but the present invention is not limited thereto. In an exemplary embodiment shown in FIG. 8, each of the transistors YscL, Yfr1, Yfr2, Yrr, and SL is illustrated to be an N-channel field effect transistor (FET). In this case, the control terminal, the input terminal, and the output terminal of each transistor correspond to the gate, drain, and source of the FET, respectively. Furthermore, the transistor SH is illustrated to be a P-channel FET. In this case, the control terminal, the input terminal, and the output terminal of the transistor correspond to the gate, source, and drain of the FET, respectively. A body diode may be formed in each of the FETs YscL, Yfr1, Yfr2, Yrr, and SL.

In more detail, the transistor YscL of the scan driver 410 has the drain coupled to the low voltage terminal OUTL and the source coupled to a power supply VscL supplying the VscL voltage. The capacitor CscH is coupled between the high voltage terminal OUTH and the low voltage terminal OUTL of the scan circuit 412. A power supply VscH supplying the VscH voltage is coupled to the high voltage terminal OUTH of the scan circuit 412. In this case, in order for the capacitor CscH to cut off a current path to the power supply VscH, a diode DscH may be coupled between the power supply VscH and the high voltage terminal OUTH of the scan circuit 412. The capacitor CscH is charged with a voltage (VscH−VscL) corresponding to a voltage difference between the VscH voltage and the VscL voltage when the transistor YscL is turned on.

The transistor SH of the scan circuit 412 has the source coupled to the high voltage terminal OUTH and the drain coupled to the output terminal OUT. The transistor SL of the scan circuit 412 has the drain coupled to the output terminal OUT and the source coupled to the low voltage terminal OUTL. When the transistors SH and SL are turned on/off, the scan circuit 412 sets the voltage of the Y electrode to the voltage of the high voltage terminal OUTH or the voltage of the low voltage terminal OUTL.

One scan circuit 412 may correspond to one Y electrode, and a plurality of scan circuits 412 corresponding to the plurality of respective Y electrodes (Y1-Yn in FIG. 1) may be formed in the scan driver 410. In this case, some of the plurality of scan circuits may be formed of one integrated circuit (IC), and the high voltage terminal OUTH and the low voltage terminal OUTL each may be commonly formed in these scan circuits.

In the address period, when the transistor YscL is turned on, the voltage of the low voltage terminal OUTL of the scan circuit 412 becomes the VscL voltage. Further, the transistors SL of the plurality of scan circuits 412 are sequentially turned on, and therefore the plurality of scan circuits 412 sequentially applies the VscL voltage of the low voltage terminal OUTL to the plurality of Y electrodes. The transistor SH of a scan circuit 412 whose transistor SL has not been turned on, from among the plurality of scan circuits 412, is turned on, thus applying the VscH voltage of the high voltage terminal OUTH to a Y electrode coupled thereto.

The transistor Yfr1 has the drain coupled to the low voltage terminal OUTL of the scan circuit 412 and the source coupled to a power supply Vnf. The transistor Yfr2 has the drain coupled to the high voltage terminal OUTH of the scan circuit 412 and the source coupled to a suitable voltage source (e.g., ground terminal).

The two falling reset controllers 422 and 424 operate in response to a control signal for the falling period operation of the reset period. When voltage of the high voltage terminal OUTH is higher than the ground voltage (e.g., 0V), the falling reset controller 422 gradually decreases the voltage of the Y electrode through the transistor Yfr2. The transistor Yfr2 supplies current from the high voltage terminal OUTH to the ground terminal under the control of the falling reset controller 422, thereby gradually decreasing the voltage of the high voltage terminal OUTH to 0V. The (VscH−VscL) voltage charged at the capacitor CscH causes the voltage of the Y electrode to gradually decrease to −(VscH−VscL) voltage via the transistor SL of the scan circuit 412, the capacitor CscH, and the transistor Yfr2. Here, when the voltage of the high voltage terminal OUTH is lower than the ground voltage, the falling reset controller 424 gradually decreases the voltage of the Y electrode through the transistor Yfr1. In response thereto, the transistor Yfr1 supplies current from the Y electrode to the power supply Vnf via the transistor SL of the scan circuit 412, thereby gradually decreasing the voltage of the Y electrode to the Vnf voltage.

The current cut-off element D1 is coupled between the drain of the transistor Yfr2 and the high voltage terminal OUTH of the scan circuit 412. When the voltage of the Y electrode decreases to the ground voltage or less, the current cut-off element D1 cuts off a current path that can be formed from the ground terminal to the low voltage terminal OUTL via the capacitor CscH and the transistor Yfr2. As shown in FIG. 3, the diode D1 as the current cut-off element has a cathode coupled to the drain of the transistor Yfr2 and an anode coupled to the high voltage terminal OUTH. In another embodiment, a transistor may be used as the current cut-off element D1.

The falling reset controller 422 can include, for example, a resistor R1 and a gate driver 422a. The falling reset controller 424 can include, for example, a capacitor C1, a resistor R2, and a gate driver 424a.

The resistor R1 of the falling reset controller 422 has one terminal coupled to the source of the transistor Yfr2 and the other terminal coupled to the ground terminal. The gate driver 422a has a reference voltage terminal REF1, an input terminal GIN1, and an output terminal GOUT1. The reference voltage terminal REF1 coupled to the ground terminal determines a reference voltage of the gate driver 422a. In another embodiment, a resistor may be coupled between the gate of the transistor Yfr2 and the output terminal GOUT1 of the gate driver 422a.

The gate driver 424a has a reference voltage terminal REF2, an input terminal GIN2, and an output terminal GOUT2. The reference voltage terminal REF2 coupled to the source of the transistor Yfr1 determines a reference voltage of the gate driver 424a. The capacitor C1 is coupled between the output terminal GOUT2 of the gate driver 424a and the drain of the transistor Yfr1. The resistor R2 is coupled between the capacitor C1 and the output terminal GOUT2 of the gate driver 424a.

The two gate drivers 422a and 424a operate in response to the control signal, which is inputted to the respective input terminals GIN1 and GIN2, and output gate signals through the respective output terminals GOUT1 and GOUT2. When the control signal for the falling period operation of the reset period is received through the input terminals GIN1 and GIN2, the two gate drivers 422a and 424a raise voltages of the respective gate signals higher than voltages of the respective reference voltage terminals REF1 and REF2 in order to turn on the respective transistors Yfr1 and Yfr2.

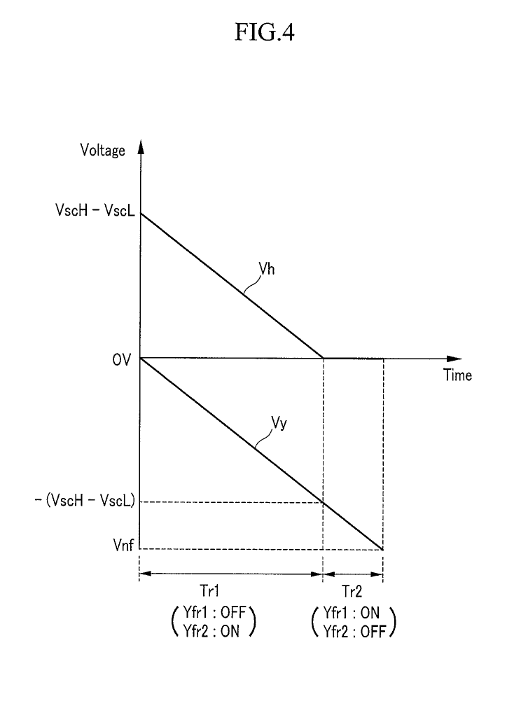

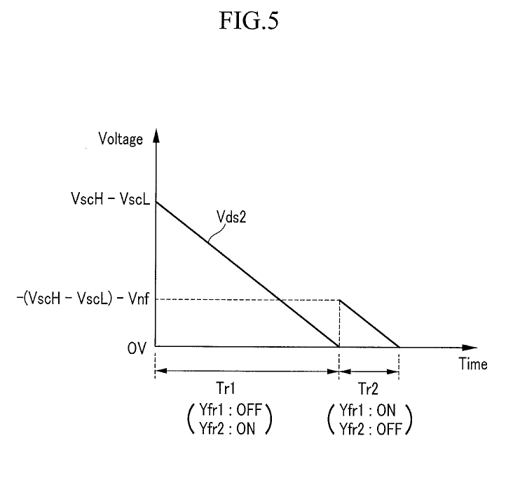

The operation of the falling reset driver 420 is described below in more detail with reference to FIGS. 4 and 5.

FIGS. 4 and 5 are diagrams showing voltages of the falling reset driver 420 according to an exemplary embodiment.

It is hereinafter assumed that the voltage of the Y electrode right before the operation of the falling reset driver 420 is 0V with reference to the driving waveforms of FIG. 2. In this case, a Vh voltage of the high voltage terminal OUTH of the scan circuit 412 becomes the (VscH−VscL) voltage via the capacitor CscH. During the rising reset period, the transistor SL of the scan circuit 412 is turned on, and therefore the voltage of the Y electrode is set to the voltage of the low voltage terminal OUTL of the scan circuit 412.

First, the gate drivers 422a and 424a increase the voltages of respective gate signals for the operation of the falling reset driver 420 in response to the control signal inputted to the respective input terminals GIN1 and GIN2. A gate voltage of the transistor Yfr1 is increased in the form of an RC waveform determined by the resistor R2 and the capacitor C1, and a gate voltage of the transistor Yfr2 immediately (or rapidly) rises unlike the gate voltage of the transistor Yfr1. Accordingly, the gate-source voltage of the transistor Yfr2 first exceeds a threshold voltage, then the gate-source voltage of the transistor Yfr1 exceeds a threshold voltage.

When the gate-source voltage of the transistor Yfr2 exceeds the threshold voltage, the transistor Yfr2 is turned on. Accordingly, current flows from the Y electrode to the ground terminal via the transistor SL, the capacitor CscH, the transistor Yfr2, and the resistor R1. As shown in FIG. 4, the voltage of the Y electrode is decreased from 0V, and the Vh voltage of the high voltage terminal OUTH of the scan circuit 412 is decreased from the (VscH−VscL) voltage. The current flowing through the resistor R1 causes the voltage across the resistor R1 to increase. Thus, the source voltage of the transistor Yfr2 is increased, and the gate-source voltage of the transistor Yfr2 is decreased. Accordingly, the transistor Yfr2 is turned off when the gate-source voltage is below the threshold voltage.

When the transistor Yfr2 is turned off, the gate voltage of the transistor Yfr2 is increased again in response to the gate signal of the gate driver 422a. Accordingly, when the gate-source voltage of the transistor Yfr2 exceeds the threshold voltage of the transistor Yfr2, the transistor Yfr2 is again turned on.

A process in which the voltage of the Y electrode is decreased by the turn-on of the transistor Yfr2, a process in which the transistor Yfr2 is turned off by a reduction in the voltage of the Y electrode, and a process in which the transistor Yfr2 is again turned on after the turn-off of the transistor Yfr2 are repeated. Through the repetition of the above processes, the gate-source voltage of the transistor Yfr2 slightly exceeds the threshold voltage of the transistor Yfr2 and then slightly drops. Accordingly, the gate-source voltage of the transistor Yfr2 is substantially maintained near the threshold voltage of the transistor Yfr2. Accordingly, a minute current flows through the transistor Yfr2 and a minute current flows from a panel capacitor formed by the Y electrode. Consequently, as shown in FIG. 4, the voltage (Vy) of the Y electrode and the Vh voltage of the high voltage terminal OUTH of the scan circuit 412 gradually decrease in a ramp pattern.

There continues a first-half falling period Tr1 in which the turn-on and the turn-off of the transistor Yfr2 are repeated until the high voltage terminal voltage (Vh) of the scan circuit 412 becomes equal to the voltage of the ground terminal (i.e., 0V) as shown in FIG. 4. Here, the gate voltage of the transistor Yfr1 can be increased by the gate signal during the period Tr1, but voltage charged at the capacitor C1 is also discharged through the transistor Yfr2 when the voltage of the Y electrode is decreased. Thus, the gate voltage of the transistor Yfr1 is not substantially increased by the voltage of the capacitor C1. Accordingly, during the first-half falling period Tr1, the transistor Yfr1 substantially maintains a turn-off state.

Here, when the Vh voltage of the high voltage terminal OUTH is decreased to 0V by the drop of the Y electrode voltage (Vy), the transistor Yfr2 maintains a turn-off state because the drain-source voltage of the transistor Yfr2 is 0V. Here, the voltage of the Y electrode has been decreased to the −(VscH−VscL) voltage by the capacitor CscH. Further, the gate voltage of the transistor Yfr1 is increased in the form of an RC waveform in response to the gate signal of the gate driver 424a, and therefore a second-half falling, period Tr2 starts.

When the gate-source voltage of the transistor Yfr1 exceeds the threshold voltage of the transistor Yfr1 due to an increase in the gate voltage, the transistor Yfr1 is turned on. When the transistor Yfr1 is turned on, current is supplied from the Y electrode to the power supply Vnf through the two transistors SL and Yfr1. Thus, the voltage of the Y electrode is decreased, and therefore the drain voltage of the transistor Yfr1 is decreased. Since the gate voltage of the transistor Yfr1 is decreased by the capacitor C1, the gate-source voltage of the transistor Yfr1 is decreased, thereby turning off the transistor Yfr1.

When the transistor Yfr1 is turned off, the gate voltage of the transistor Yfr1 is increased in response to the gate signal of the gate driver 424a and is again increased in the form of an RC pattern. Accordingly, when the gate-source voltage of the transistor Yfr1 exceeds the threshold voltage of the transistor Yfr1, the transistor Yfr1 is again turned on.

As described above, a process in which the voltage of the Y electrode is decreased by the turn-on of the transistor Yfr1, a process in which the transistor Yfr1 is turned off by a reduction in the voltage of the Y electrode, and a process in which the transistor Yfr1 is again turned on after the turn-off of the transistor Yfr1 are repeated. Through the repetition of the above described processes, the gate-source voltage of the transistor Yfr1 is substantially maintained near the threshold voltage of the transistor Yfr1. Accordingly, a minute current flows through the transistor Yfr1, and a minute current flows from a panel capacitor formed by the Y electrode. Thus, as shown in FIG. 4, the voltage (Vy) of the Y electrode gradually decreases to the Vnf voltage in a ramp pattern.

Here, in the first-half falling period Tr1, the transistor Yfr1 is substantially in a turn-off state, and the drain voltage of the transistor Yfr2 is gradually decreased from the (VscH−VscL) voltage to 0V. Thus, during the first-half falling period Tr1, a drain-source voltage (Vds2) of the transistor Yfr2 is gradually decreased from the (VscH−VscL) voltage to 0V. Accordingly, power P1 consumed in the first-half falling period Tr1 is expressed in Equation 1. In the second-half falling period Tr2, the transistor Yfr2 is in a turn-off state, and the drain voltage of the transistor Yfr1 is gradually decreased from the −(VscH−VscL) voltage to the Vnf voltage. Thus, during the second-half falling period Tr2, a drain-source voltage (Vds1) of the transistor Yfr1 is gradually decreased from a −(VscH−VscL)−Vnf voltage to 0V. Accordingly, power P2 consumed in the second-half falling period Tr2 is expressed in Equation 2. During the falling period of the reset period, power P3 consumed in the two transistors Yfr1 and Yfr2 is expressed in Equation 3.

P1=1/2*Cp*(VscH−VscL)² Equation 1

P2=1/2*Cp*(VscH−VscL+Vnf)² Equation 2

P3=P1+P2=1/2*Cp*{(Vnf)²+2*(VscH−VscL)*(VscH−VscL+Vnf)} Equation 3

In another embodiment, in the case where the voltage of the Y electrode is gradually decreased from 0V to the Vnf voltage using one transistor, a drain-source voltage of the transistor is gradually decreased from −Vnf to 0V. Thus, power P4 consumed through the transistor is expressed in Equation 4. Since the (VscH−VscL+Vnf) voltage is negative, the power P4 is always greater than the power P3 consumed in the two transistors Yfr1 and Yfr2.

P4=1/2*Cp*(Vnf)²>P3 Equation 4

Since the amount of heat generated in the above described transistors Yfr1 and Yfr2 is small, heat sinks attached to the transistors Yfr1 and Yfr2 can be made thin or removed. Accordingly, the thickness of a plasma display device can be made small according to the above described embodiments.

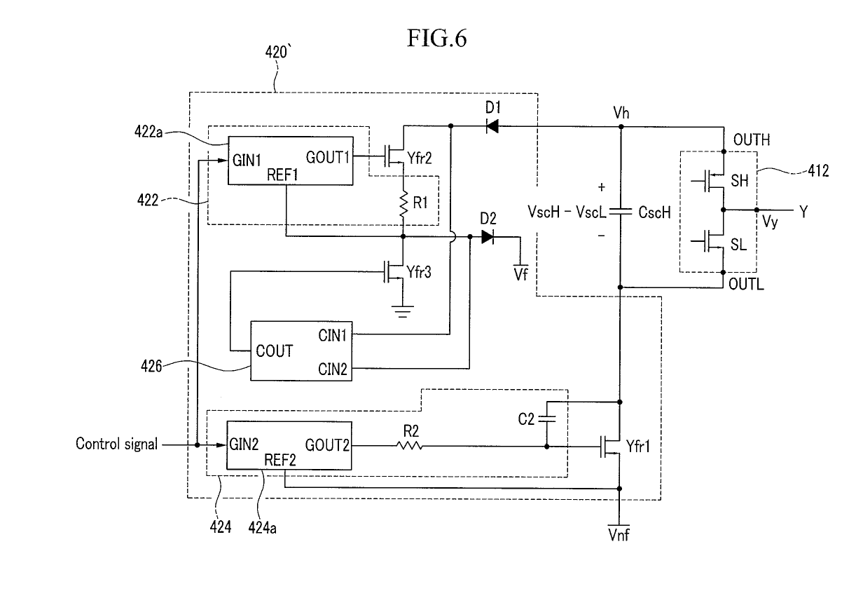

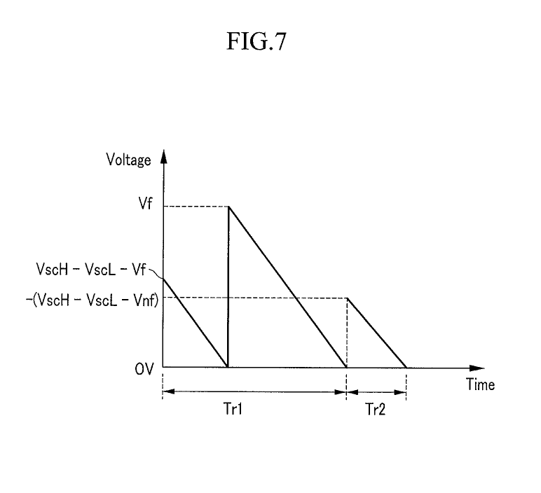

FIG. 6 is a schematic circuit diagram of a falling reset driver 420′ according to another exemplary embodiment, and FIG. 7 is a diagram showing voltages of the falling reset driver 420′ according to another exemplary embodiment.

Referring to FIG. 6, the falling reset driver 420′ further includes a transistor Yfr3, a current cut-off element D2, and a comparator 426 as compared to the falling reset driver 420 shown in FIG. 3.

Unlike in the falling reset driver 420 shown in FIG. 3, the other terminal of the resistor R1 is coupled to the power supply Vf supplying the Vf voltage, and the transistor Yfr3 is coupled between the other terminal of the resistor R1 and the ground terminal. The Vf voltage has a positive voltage lower than a (VscH−VscL) voltage. In this case, when a source voltage of the transistor Yfr2 is lower than the Vf voltage, the current cut-off element D2 can be coupled between the resistor R1 and the power supply Vf in order to prevent a current path from being formed from the power Vf to the source of the transistor Yfr2. A diode D2 having an anode coupled to the other terminal of the resistor R1 and a cathode coupled to the power supply Vf can be used as the current cut-off element D2. In another embodiment, a transistor may be used as the current cut-off element D2.

The transistor Yfr3 has the drain coupled to the other terminal of the resistor R1 and the source coupled to the ground terminal. A resistor may be coupled between the gate and the source of the transistor Yfr3.

The comparator 426 has two input terminals CIN1 and CIN2 and an output terminal COUT. The input terminal CIN1 is coupled to the drain of the transistor Yfr2 or the high voltage terminal OUTH of the scan circuit 412, and the input terminal CIN2 is coupled to the power supply Vf via the current cut-off element D2.

In this case, in the first-half falling period Tr1, when the voltage (Vh) of the high voltage terminal OUTH is higher than the Vf voltage, current flows from the Y electrode to the power supply Vf via the transistor SL, the capacitor CscH, the transistor Yfr2, and the resistor R1. Accordingly, the voltage (Vh) of the high voltage terminal OUTH can be gradually decreased from the (VscH−VscL) voltage to the Vf voltage. Furthermore, a voltage (Vy) of the Y electrode is gradually decreased from 0V to a −(VscH−VscL−Vf) voltage. In this case, the drain-source voltage (Vds2) of the transistor Yfr2 is gradually decreased from the (VscH−VscL−Vf) voltage to 0V, as shown in FIG. 7. During this period, power P5 expressed in Equation 5 is consumed.

In the first-half falling period Tr1, when the voltage (Vh) of the high voltage terminal OUTH becomes the Vf voltage, the voltages of the two input terminals CIN1 and CIN2 of the comparator 426 become equal to each other, and therefore the comparator 426 outputs a voltage higher than 0V to the gate of the transistor Yfr3 through the output terminal COUT. Thus, the transistor Yfr3 is turned on, and current flows from the Y electrode to the ground terminal via the transistor SL, the capacitor CscH, the transistor Yfr2, the resistor R1, and the transistor Yfr3. Accordingly, the voltage (Vh) of the high voltage terminal OUTH can be gradually decreased from the Vf voltage to 0V. Furthermore, the Y electrode voltage (Vy) is gradually decreased from the −(VscH−VscL−Vf) voltage to the −(VscH−VscL) voltage. In this case, as shown in FIG. 7, the drain-source voltage (Vds2) of the transistor Yfr2 is gradually decreased from the Vf voltage to 0V. During this period, power P6 expressed in Equation 6 is consumed.

Next, in a second-half falling period Tr2, the Y electrode voltage (Vy) is gradually decreased from the −(VscH−VscL) voltage to the Vnf voltage as described above with reference to FIGS. 3 and 4. During this period, the power P2 expressed in Equation 2 is consumed.

Accordingly, power P7 consumed in the falling reset driver 420′ during the falling period is expressed in Equation 7. While the falling reset driver 420′ includes the additional elements as compared to the falling reset driver 420, the power P7 of Equation 7 is smaller than the power P3 of Equation 3. That is, the falling reset driver 420′ can reduce power consumption as compared to the falling reset driver 420.

P5=1/2*Cp*(VscH−VscL−Vf)² Equation 5

P6=1/2*Cp*(Vf)² Equation 6

P7=P5+P6+P2=P1+P2−Cp*Vf*(VscH−VscL−Vf)<P3 Equation 7

Examples of the rising reset driver 430 and the sustain driver 440 of the scan electrode driver 400 shown in FIG. 3 are described below with reference to FIG. 8.

FIG. 8 is a schematic circuit diagram of a scan electrode driver 400′ according to another exemplary embodiment.

Referring to FIG. 8, a rising reset driver 430′ includes a transistor Yrr. A sustain driver 440′ includes transistors Ys, Yg, Yr, and Yf, an inductor L1, and an energy recovery capacitor Cerc.

In the exemplary embodiment shown in FIG. 8, each of the transistors Ys, Yg, Yr, and Yf is illustrated to be an insulated gate bipolar transistor (IGBT). In this case, the control terminal, the input terminal, and the output terminal of each transistor correspond to the gate, collector, and emitter of the IGBT, respectively. Furthermore, the transistor Yrr is illustrated to be an N-channel FET. In this case, the control terminal, the input terminal, and the output terminal of the transistor correspond to the gate, drain, and source of the N-channel FET, respectively.

In the rising reset driver 430′, the transistor Yrr has the source coupled to the low voltage terminal OUTL of the scan circuit 412 (i.e., one terminal of the capacitor CscH) and the drain coupled to a power supply Vset supplying a Vset voltage.

In the rising period of the reset period, in the state in which a ground voltage has been applied to the Y electrode, the transistor SL of the scan circuit 412 is turned off and the transistor SH thereof is turned on. In response thereto, the (VscH−VscL) voltage charged at the capacitor CscH is applied to the Y electrode. Further, the transistor Yrr is operated such that it allows a minute current to flow therethrough in a way similar to the transistors Yfr1 and Yfr2 of the falling reset driver 420. Thus, current supplied from the power supply Vset via the transistor Yrr is supplied to a panel capacitor formed by the Y electrode via the capacitor CscH and the transistor SH. Accordingly, the voltage of the Y electrode is gradually increased from the (VscH−VscL) voltage up to a (Vset+VscH−VscL) voltage. Here, the V1 voltage shown in FIG. 2 corresponds to the (VscH−VscL) voltage.

The transistor Ys of the sustain driver 440′ has the collector coupled to a power supply that supplies a high voltage (Vs) of a sustain pulse and the emitter coupled to the Y electrode via the low voltage terminal OUTL of the scan circuit 412. The transistor Ys is turned on when the high voltage (Vs) of the sustain pulse is supplied to the Y electrode in the sustain period. The transistor Yg has the collector coupled to the Y electrode via the low voltage terminal OUTL of the scan circuit 412 and the emitter coupled to a power supply that supplies a low voltage of a sustain pulse (e.g., ground terminal). The transistor Yg is turned on when the low voltage of the sustain pulse is supplied to the Y electrode in the sustain period and a ground voltage is supplied to the Y electrode in the reset period.

The emitter of the transistor Yr and the collector of the transistor Yf are coupled to the Y electrode via the low voltage terminal OUTL of the scan circuit 412, and the collector of the transistor Yr and the emitter of the transistor Yf are coupled to one terminal of the inductor L1. The other terminal of the inductor L1 is coupled to one terminal of the capacitor Cerc, and the other terminal of the capacitor Cerc is coupled to a ground terminal. A voltage (Verc) charged at the capacitor Cerc is between the high voltage (Vs) and the low voltage, and may be, for example, a voltage (Vs/2) corresponding to half the voltage difference between the high voltage (Vs) and the low voltage. In this case, if the Vf voltage described above with reference to FIG. 6 is set in the same manner as the Verc voltage, the power supply that supplies the Vf voltage can be obviated.

The transistor Yr is turned on before the transistor Ys is turned on in the sustain period. Resonance is generated between the inductor L1 and the panel capacitor by the turn-on of the transistor Yr, and therefore the panel capacitor is charged with the energy charged at the capacitor Cerc. Accordingly, the voltage of the Y electrode is increased from 0V to near the Vs voltage. The transistor Yf is turned on before the transistor Yg is turned on in the sustain period. Resonance is generated between the inductor L1 and the panel capacitor by the turn-on of the transistor Yf, and therefore energy discharged from the panel capacitor is recovered by the capacitor Cerc. Accordingly, the voltage of the Y electrode is decreased from the Vs voltage to near 0V. Here, in order to form a path for charging the panel capacitor, a diode Dr may be coupled in series to the transistor Yr. In order to form a path for discharging the panel capacitor, a diode Df may be coupled in series to the transistor Yf.

Since the Vnf voltage or the VscL voltage is a negative voltage, in order to prevent current from flowing from the ground terminal to the power supplies Vnf and VscL via a diode Dg when the transistors Yfr1 and YscL are turned on, a transistor Ypn may be formed on the path. That is, the transistor Ypn may have the drain coupled to the cathode of the diode Dg and the source coupled to the drain of the transistors YscL and Yfr.

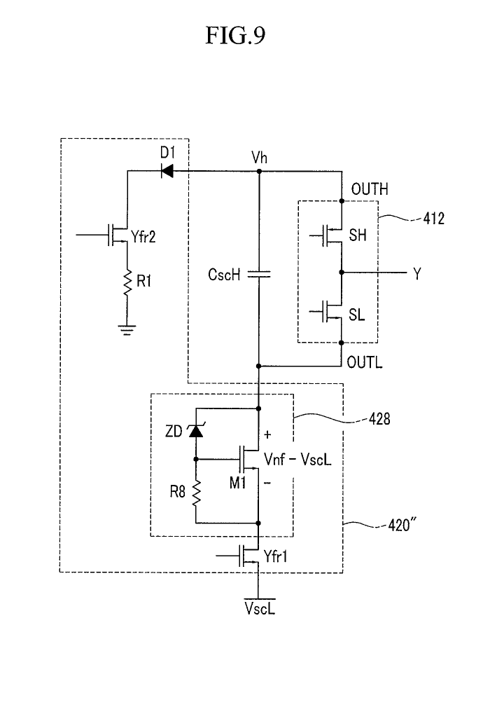

FIG. 9 is a schematic circuit diagram of a falling reset driver 420″ according to another exemplary embodiment.

Referring to FIG. 9, the falling reset driver 420″ further includes a voltage generation circuit 428 coupled in series to the transistor Yfr1 between the low voltage terminal OUTL of the scan circuit 412 and the power supply VscL that supplies the VscL voltage as compared to the falling reset drivers of the previous embodiments. The voltage generation circuit 428 may include, for example, a transistor M1, a Zener diode ZD, and a resistor R8.

The transistor M1 has the drain coupled to the low voltage terminal OUTL and the source coupled to the drain of the transistor Yfr1. The Zener diode ZD is coupled between the drain and the gate of the transistor M1, and the resistor R8 is coupled between the gate and the source of the transistor M1.

In the falling period of the reset period, when the transistor Yfr1 is turned on and therefore current flows from the Y electrode via the transistor Yfr1, the current first flows through the Zener diode ZD and the resistor R8. Thus, when voltage applied across the resistor R8 is increased and therefore the transistor M1 is turned on, the current is supplied to the power supply VscL via the two transistors M1 and Yfr1. In this case, a drain-source voltage (Vds3) of the transistor M1 is the sum of a breakdown voltage (Vz) of the Zener diode ZD and a voltage (VR) across the resistor R8, which is expressed in Equation 12. Here, the current flowing through the resistor R8 depends on current flowing through the transistor Yfr1 during the falling period. Thus, if the breakdown voltage (Vz) of the Zener diode ZD or the size of the resistor R8 or both are determined such that the (Vz+VR) voltage equals the (Vnf−VscL) voltage, voltage of the Y electrode can be reduced to the Vnf voltage. In this manner, the power supply that supplies the Vnf voltage can be obviated.

Vds3=Vz+VR=Vnf−VscL Equation 12

Here, although the transistor M1 is illustrated to be an N-channel FET in FIG. 9, another suitable switch may be used as the transistor M1. Furthermore, although, in FIG. 9, the voltage generation circuit 428 is illustrated to be coupled to the falling reset driver 420 of FIG. 3, the voltage generation circuit 428 may also be coupled to the falling reset drivers 420′ and 420 of FIGS. 6 and 8.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display device comprising:
a scan electrode;
a scan circuit having a high voltage terminal and a low voltage terminal and configured to set a voltage of the scan electrode to a voltage of the high voltage terminal or a voltage of the low voltage terminal;
a first capacitor coupled between the high voltage terminal and the low voltage terminal;
a first transistor coupled between the high voltage terminal and a first power supply for supplying a first voltage;
a first falling reset controller configured to operate the first transistor such that the voltage of the scan electrode gradually decreases to a second voltage through the low voltage terminal and the first capacitor during a first period of a reset period;
a second transistor coupled between the low voltage terminal and a second power supply for supplying a third voltage that is lower than the second voltage; and
a second falling reset controller configured to operate the second transistor such that the voltage of the scan electrode gradually decreases from the second voltage to a fourth voltage that is lower than the second voltage through the low voltage terminal during a second period of the reset period.

2. The plasma display device of claim 1, further comprising
a current cut-off element coupled between the high voltage terminal and a first terminal of the first transistor and configured to block a current from the first terminal of the first transistor toward the high voltage terminal,
wherein a second terminal of the first transistor is coupled to the first power supply.

3. The plasma display device of claim 2, wherein
the current cut-off element comprises a diode having an anode coupled to the high voltage terminal and a cathode coupled to the first terminal of the first transistor.

4. The plasma display device of claim 1, further comprising
a third transistor coupled in series to the first transistor between the high voltage terminal and the first power supply,
wherein a node between the first transistor and the third transistor is coupled to a third power supply for supplying a fifth voltage that is higher than the first voltage.

5. The plasma display device of claim 4, wherein
the first falling reset driver is configured to
gradually decrease the voltage of the scan electrode to a sixth voltage that is higher than the second voltage through a path formed from the low voltage terminal to the third power supply via the first capacitor and the first transistor during a third period of the first period, and
gradually decreases the voltage of the scan electrode to the second voltage through a path formed from the low voltage terminal to the first power supply via the first capacitor and the first and third transistors during a fourth period of the first period.

6. The plasma display device of claim 5, further comprising:
a comparator configured to turn on the third transistor when the fifth voltage is higher than the voltage of the high voltage terminal.

7. The plasma display device of claim 4, further comprising:
a current cut-off element coupled between the node and the third power supply and configured to block a current from the third power supply toward the node.

8. The plasma display device of claim 7, wherein
the current cut-off element comprises a diode having an anode coupled to the node and a cathode coupled to the third power supply.

9. The plasma display device of claim 4, further comprising
a second capacitor configured to supply the scan electrode with energy charged therein during a sustain period and to recover energy discharged from the scan electrode,
wherein the fifth voltage is a voltage supplied from the second capacitor.

10. The plasma display device of claim 1, wherein:
the first transistor has a control terminal, a first terminal coupled to the high voltage terminal, and a second terminal coupled to the first power supply, and
the first falling reset controller comprises:
a first resistor having a first terminal coupled to the second terminal of the first transistor and a second terminal coupled to the first power supply, and
a first gate driver configured to apply a gate signal to the control terminal of the first transistor and to utilize a voltage of the second terminal of the first resistor as a reference voltage.

11. The plasma display device of claim 10, wherein:
the second transistor has a control terminal, a first terminal coupled to the low voltage terminal, and a second terminal coupled to the second power supply, and
the second falling reset controller comprises:
a second capacitor coupled between the first terminal and the control terminal of the second transistor,
a second gate driver configured to output a gate signal to an output terminal of the second gate driver and to utilize a voltage of the second terminal of the second transistor as a reference voltage, and
a second resistor coupled between the output terminal of the second gate driver and the control terminal of the second transistor.

12. The plasma display device of claim 1, wherein
the first capacitor is configured to store a voltage corresponding to a difference between the first voltage and the second voltage.

13. The plasma display device of claim 1, wherein
the third voltage equals the fourth voltage.

14. The plasma display device of claim 1, further comprising
a voltage generation circuit coupled in series to the second transistor between the low voltage terminal and the second power supply,
wherein when the second transistor operates, the voltage generation circuit generates a voltage corresponding to a voltage difference between the third voltage and the fourth voltage.

15. A method of driving a plasma display device comprising a scan electrode, a scan circuit having a high voltage terminal and a low voltage terminal and configured to set a voltage of the scan electrode to a voltage of the high voltage terminal or a voltage of the low voltage terminal, and a capacitor coupled between the high voltage terminal and the low voltage terminal, the method comprising:
electrically coupling the low voltage terminal to the scan electrode during a falling period of a reset period;
gradually decreasing the voltage of the scan electrode to a first voltage through the low voltage terminal and the capacitor during a first period of the falling period; and
gradually decreasing the voltage of the scan electrode from the first voltage to a second voltage through the low voltage terminal without utilizing the capacitor during a second period of the falling period.

16. The method of claim 15, wherein:
said gradually decreasing the voltage of the scan electrode to the first voltage comprises gradually decreasing the voltage of the scan electrode to the first voltage through a path formed by the low voltage terminal, the capacitor, and a first power supply for supplying a third voltage,
said gradually decreasing the voltage of the scan electrode from the first voltage to the second voltage comprises gradually decreasing the voltage of the scan electrode to the second voltage through a path formed by the low voltage terminal and a second power supply for supplying a voltage corresponding to the second voltage, and
the capacitor is charged with a voltage corresponding to a voltage difference between the third voltage and the first voltage.

17. The method of claim 15, wherein:
said gradually decreasing the voltage of the scan electrode to the first voltage comprises:
gradually decreasing the voltage of the scan electrode to a fourth voltage through a path formed by the low voltage terminal, the capacitor, and a first power supply for supplying a third voltage, and
gradually decreasing the voltage of the scan electrode to the first voltage through a path formed by the low voltage terminal, the capacitor, and a second power supply for supplying a fifth voltage,
wherein said gradually decreasing the voltage of the scan electrode from the first voltage to the second voltage comprises gradually decreasing the voltage of the scan electrode to the second voltage through a path formed by the low voltage terminal and a third power supply for supplying a voltage corresponding to the second voltage,
wherein the capacitor is charged with a voltage corresponding to a voltage difference between the fifth voltage and the first voltage, and
wherein a voltage difference between the fourth voltage and the first voltage equals a voltage difference between the third voltage and the fifth voltage.

18. A plasma display device comprising:
a scan electrode;
a scan circuit having a high voltage terminal and a low voltage terminal and configured to set a voltage of the scan electrode to a voltage of the high voltage terminal or a voltage of the low voltage terminal;
a first capacitor coupled between the high voltage terminal and the low voltage terminal;
a first current cut-off element having a first terminal and a second terminal coupled to the high voltage terminal and configured to block a current from the first terminal toward the second terminal;
a first transistor having a drain coupled to the first terminal of the first current cut-off element;
a first resistor having a first terminal coupled to a source of the first transistor and a second terminal coupled to a first power supply for supplying a first voltage;
a first gate driver configured to utilize a voltage of the second terminal of the first resistor as a reference and to supply a first gate signal to a gate of the first transistor;
a second transistor coupled between the low voltage terminal and a second power supply for supplying a second voltage;
a second capacitor coupled between a drain and a gate of the second transistor;
a second gate driver configured to utilize a source voltage of the second transistor as a reference and to output a second gate signal to an output terminal of the second gate driver; and
a second resistor coupled between the output terminal of the second gate driver and the gate of the second transistor.

19. The plasma display device of claim 18, further comprising:
a third transistor coupled between the second terminal of the first resistor and the first power supply; and
a second current cut-off element having a first terminal coupled to a third power supply for supplying a third voltage higher than the first voltage and a second terminal coupled to the second terminal of the first resistor and configured to cut off a current from the first terminal toward the second terminal.

20. The plasma display device of claim 19, further comprising:
a comparator configured to turn on the third transistor when the third voltage is higher than the voltage of the high voltage terminal.
